(19) United States
(12) Patent Application Publication
(10) Pub. No.: US 2011/0129199 A1
(43) Pub. Date: Jun. 2, 2011

(54) FACILITATING PLAYBACK OF RECORDED CONTENT CONTAINING A SERVICE TRANSITION

(75) Inventors: Christopher S. Del Sordo, Souderton, PA (US); Louis D. Bifano, Morrisville, PA (US); Scott D. Sellers, Quakertown, PA (US)

(73) Assignee: GENERAL INSTRUMENT CORPORATION, Horsham, PA (US)

(21) Appl. No.: 12/623,516

(22) Filed: Nov. 23, 2009

(51) Int. Cl. H04N 7/00; H04N 7/26; H04N 9/80

(52) U.S. Cl. 386/241; 386/E05.001; 386/249

(57) ABSTRACT

A method for facilitating playback of recorded content having a service transition point is provided. The method includes recording content containing a pre-transition service and a post-transition service, in which the pre-transition service occurs prior to the service transition point and the post-transition service occurs after the service transition point. The method also includes generating a content change file having content change records associated with the pre-transition service, the service transition point, and the post-transition service, and communicating the content and the content change file to a playback device configured to play the recorded content.

### RELATED APPLICATIONS

The present application is related to U.S. patent application Ser. No. (TBD) (Attorney Docket No. BCS05026), entitled “Transitioning Between Multiple Services In An Mpeg Stream”, by Christopher Del Sordo et al., the disclosure of which is incorporated by reference in its entirety.

### BACKGROUND

Video content is known to be transported over MPEG streams, such as, MPEG-2 and MPEG-4 streams, to set top boxes from cable operators and other content providers. Each of the packets in the MPEG streams includes a header containing various information, such as, flags, a countdown field, and a 13 bit packet identifier (PID) field that identifies the portion of a packetized elementary stream (PES) for each of the packets. In addition, all of the packets in a PID stream have the same values, which may be assigned for each element of a PES, for instance for each frame of an audio elementary stream or each picture of a video elementary stream.

A program clock reference (PCR) is one of several auxiliary PID streams and contains samples of a 27 MHz clock used by the video and audio encoders and decoders. The PCR is carried by a PID stream with a PID called the PCR_PID. A program map table (PMT) is carried in another auxiliary PID stream and lists all the PID's that belong to the program and defines which PID streams contain which elements (video, audio channels, captions, PCR_PID).

The MPEG streams often include multiple services with packets for different programs multiplexed together. Consequently, the decoder has to be configured to select the packets of a program in order to decode a particular program. The decoder performs this function using a program association table (PAT) that lists the PID streams containing the PMT's for each of the programs. The PAT is carried in another auxiliary PID stream and is known to be carried in packets with a PID value of 0.

### SUMMARY

Disclosed herein is a method for facilitating playback of recorded content having a service transition point. In the method, content containing a pre-transition service and a post-transition service is recorded. In addition, a content change file having content change records associated with the pre-transition service, the service transition point, and the post-transition service is generated, and the content and the content change file are communicated to a playback device configured to play the recorded content.

Also disclosed herein is a digital video recorder. The digital video recorder includes a recording module configured to record content having a pre-transition service, a service transition point, and a post-transition service, a content change file generating module configured to generate a content change file having a plurality of content change records associated with the pre-transition service, the service transition point, and the post-transition service, and a communication module configured to communicate the content and the content change file to a playback device configured to play the recorded content.

Further disclosed is a computer readable storage medium on which is embedded one or more computer programs. The one or more computer programs implement a method for facilitating playback of recorded content containing a service transition point. The one or more computer programs includes a set of instructions for recording content having a pre-transition service and a post-transition service. In addition, the one or more computer programs comprise a set of instructions for generating a content change file having a plurality of content change records associated with the pre-transition service, the service transition point, and the post-transition service. Further, the one or more computer programs comprise a set of instructions for communicating the content and the content change file to a playback device configured to play the recorded content.

Through implementation of the method and digital video recorder disclosed herein, a playback device may receive the recorded content and content change file from the digital video recorder and may use the content change file to facilitate seamless playback of the recorded content. More particularly, the playback device may be able to seamlessly play the transitions between pre-transition services and post-transition services having different sets of packet identifiers (PIDs) through implementation of the method and digital video recorder disclosed herein.

### BRIEF DESCRIPTION OF THE DRAWINGS

Features of the present invention will become apparent to those skilled in the art from the following description with reference to the figures, in which:

FIG. 1 illustrates a block diagram of a digital video recorder system, according to an embodiment of the invention;

FIG. 2 shows a simplified diagram of a program transport stream composed of a pre-transition service and a post-transition service with a service transition point positioned in the transition between the pre-transition service and the post-transition service, according to an embodiment of the present invention;

FIG. 3 illustrates a block diagram of the digital video recorder depicted in FIG. 1, according to an embodiment of the invention;

FIG. 4 illustrates a flow diagram of a method of facilitating playback of recorded content containing a service transition point, according to an embodiment of the present invention; and

FIG. 5 shows a block diagram of a computer system that may be used as a platform for executing one or more of the processes depicted in FIG. 4, according to an embodiment of the present invention.

### DETAILED DESCRIPTION

For simplicity and illustrative purposes, the present invention is described by referring mainly to exemplary embodiments. In the following description, numerous specific details are set forth to provide a thorough understanding of the embodiments. However, it will be apparent to one of ordinary skill in the art that the present invention may be practiced without limitation to these specific details. In other instances, well known methods and structures have not been described in detail to avoid unnecessarily obscuring the description of the embodiments.

Disclosed herein are a method and a digital video recorder for facilitating playback of recorded content containing a service transition point. More particularly, the method and the digital video recorder disclosed herein are configured to record content containing a pre-transition service and a post-transition service, and to generate a content change file containing a plurality of content change records associated with the pre-transition service, the service transition point, and the post-transition service. In addition, the method and the digital video recorder disclosed herein are configured to communicate the content and the content change file to a secondary device configured to playback the recorded content.

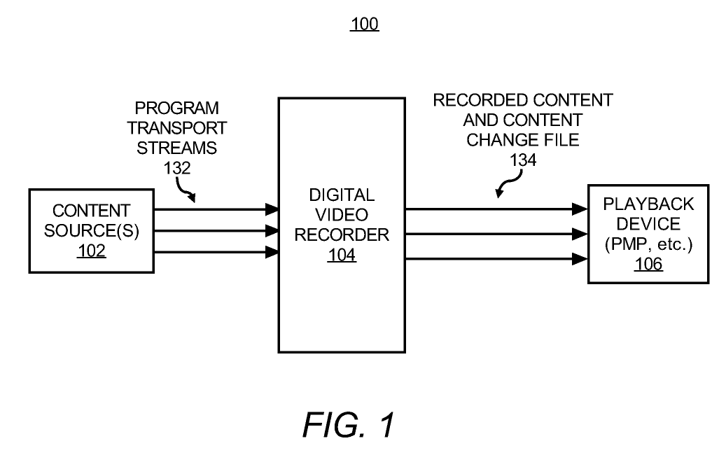

With reference first to FIG. 1, there is shown a block diagram of a digital video recorder system 100, according to an embodiment of the present invention. It should be apparent to those of ordinary skill in the art that the block diagram of FIG. 1 represents a generalized illustration and that other components may be added or existing components may be removed, modified or rearranged without departing from a scope of the digital video recorder system 100.

As depicted in FIG. 1, the digital video recorder system 100 includes one or more content sources 102, a digital video recorder (DVR) 104, and a playback device 106. The content source(s) 102 may comprise a direct source of content, such as, a network television broadcast provider, a cable television broadcast provider, a satellite television broadcast provider, a commercial advertisement provider including a targeted advertisement provider, a non-broadcast content provider, such as, a content provider configured to transport content as unicast streams, etc. In addition, the content may comprise programming offered by the content source(s) to be broadcast to users. The DVR 104 may include a DVR-integrated set-top box, a DVR-integrated satellite-TV receiver, a DVR-integrated television, a DVR-integrated computer, a DVR-integrated mobile device, etc. The playback device 106 may include a set-top box, a personal computer (PC), a mobile handset, a portable media player (PMP), etc.

In any regard, the content source(s) 102 is configured to communicate program transport streams 132 to the DVR 104, which may comprise MPEG streams. The program transport streams 132 may include audio and/or video data or information, such as streamed audio services, streamed video services, and streamed data services or files. Thus, for instance, the program transport streams 132 include content to be played and/or recorded on the DVR 104, alternative advertisements to be inserted into content, etc.

In various instances, the content and/or advertisements contained in the program transport streams 132 may have different PIDs, program numbers, service numbers, etc. This occurs, for instance, in situations where alternative advertisements are communicated to the DVR 104 in place of default advertisements in the content. This also occurs, for instance, when there are switched digital video service acquisition transitions in the communication of the content, such as may occur when the content source(s) 102 use or comprise multiple multiplexers to communicate different parts of the content to the DVR 104.

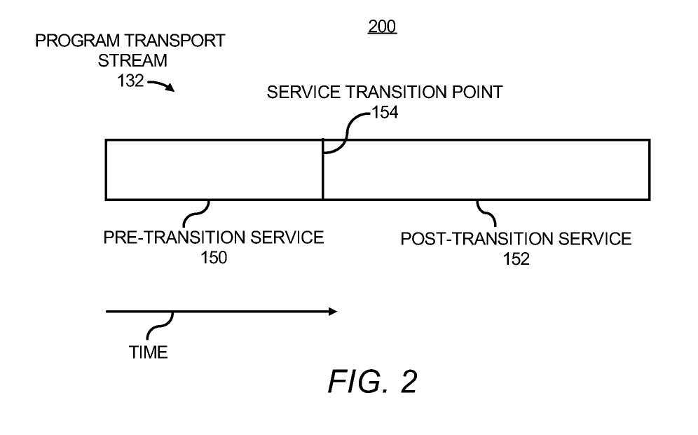

Turning now to FIG. 2, there is shown a simplified diagram 200 of a program transport stream 132 composed of a pre-transition service 150 and a post-transition service 152, with a service transition point 154 positioned in the transition between the pre-transition service 150 and the post-transition service 152, according to an embodiment of the invention. The pre-transition service 150 and the post-transition service 152 comprise different types of services, such as, for instance, programming content and advertising content, which may be received from different content source(s) 102. The pre-transition service 150 and the post-transition service 152 may also comprise services between service acquisition transitions.

The pre-transition service 150 has a first set of PIDs that indicate the type of each packet in the program transport stream 132 before the service transition point 154 and the post-transition service 152 has a second set of PIDs that indicate the type of each packet in the program transport stream 132 after the service transition point 154, in which the first set of PIDs differs from the second set of PIDs. The digital video recorder 104 may receive the pre-transition service 150 and the post-transition service 152 from different sources, for instance, separate unicast or alternately separate multicast addresses, each having a separate unique set of PIDs.

The sets of PIDs are, for instance, 13-bit code in the transport packet header of each of the pre-transition service 150 and the post-transition service 152. By way of example, MPEG-2 transmits transport stream data in packets of 188 bytes. At the start of each packet is a PID that informs the input module 112 of the packet type. For instance, a PID value of 0 indicates that the packet contains a program association table (PAT) PID. All of the packets belonging to the same elementary stream have the same PID. An MPEG-2 stream may have multiple elementary streams, each indicated by a separate PID. For instance, an APID denotes packets belonging to the audio stream and a VPID denotes packets for the video stream. A program clock reference (PCR) PID is used to synchronize the video and audio packets. Where the MPEG-2 data stream is in multi-channel per carrier (MCPC) mode, the input module 112 determines which of the incoming packets are part of the current channel being watched.

The playback device 106 is required to set up hardware video and audio decoders when play of the content starts and maintains the decoders at the settings throughout an entire play session of the content. Thus, for instance, the playback device 106 sets up the hardware video and audio decoders to play the set of PIDs of the pre-transition service 150 and updates its hardware to play the set of PIDs of the post-transition service 152. However, the playback device 106 is typically unable to seamlessly play content beyond the service transition point 154 because the player device 106 is typically unable to update its hardware to play the different sets of PIDs in sufficient time for a seamless transition. Interruptions in the play through the service transition point 154 may be even more noticeable when a rewinding or fast-forwarding operation is performed during playback of the content.

The interruptions occur because the change of values of the first set of PIDs and the second set of PIDs resets a variety of hardware in the playback device 106. More particularly, the audio decoder, the video decoder, and the PCR time clock decoders of the playback device 106 reroute with a change in the PID values causing an interruption to the MPEG stream. To substantially prevent a user from noticing that interruption, and according to an embodiment, the digital video recorder 104 generates a content change file having content change information that the playback device 106 may use to facilitate play back of recorded content having one or more service transition points. In addition, the DVR 104 may communicate the content change file with the recorded content 134 to the playback device 106 as further shown in FIG. 1 to enable such use.

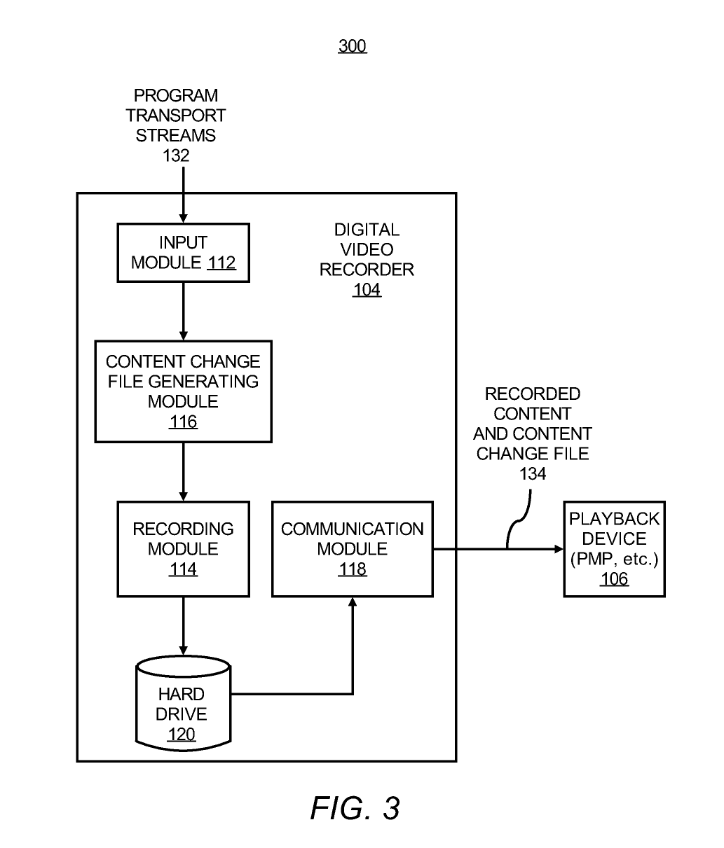

With particular reference now to FIG. 3, there is shown a block diagram 300 of the DVR 104 depicted in FIG. 1, according to an embodiment of the present invention. It should be understood that the DVR 104 depicted in FIG. 3 may include additional components and that some of the components described herein may be removed and/or modified without departing from a scope of the DVR 104.

As depicted in FIG. 3, the DVR 104 includes an input module 112, a recording module 114, a content change file generating module 116, a communication module 118, and a hard drive 120. The modules 112-118 may comprise software modules, hardware modules, or a combination of software and hardware modules. Thus, in one embodiment, one or more of the modules 112-118 comprise circuit components or other devices configured to perform the functions described herein below. In another embodiment, one or more of the modules 112-118 comprise software code stored on a computer readable storage medium, which is executable or implementable by a computing device processor (not shown) configured to perform the functions described herein below.

As shown in FIG. 3, the DVR 104 receives program transport streams 132, may include audio and/or video data or information, such as streamed audio services, streamed video services, and streamed data services or files. In addition, the program transport streams 132 may be MPEG streams. The MPEG streams may be based on MPEG-2, or on advanced video codec, for instance, MPEG-4 AVC (advanced video coding) or H.264.

The input module 112 is configured to receive program transport streams 132 containing content, which the modules 114-118 of the DVR 104 may process, and the communication module 118 is configured to communicate the processed content to a playback device 106. The communication module 118 may enable communication of the recorded content and the content change file 134 to the playback device 106 through any suitable means, including, a wired connection, a wireless connection, over a network, etc. By way of particular example, the communication module 118 is configured communicate the recorded content and the content change file 134 to the playback device 106 as an MPEG stream.

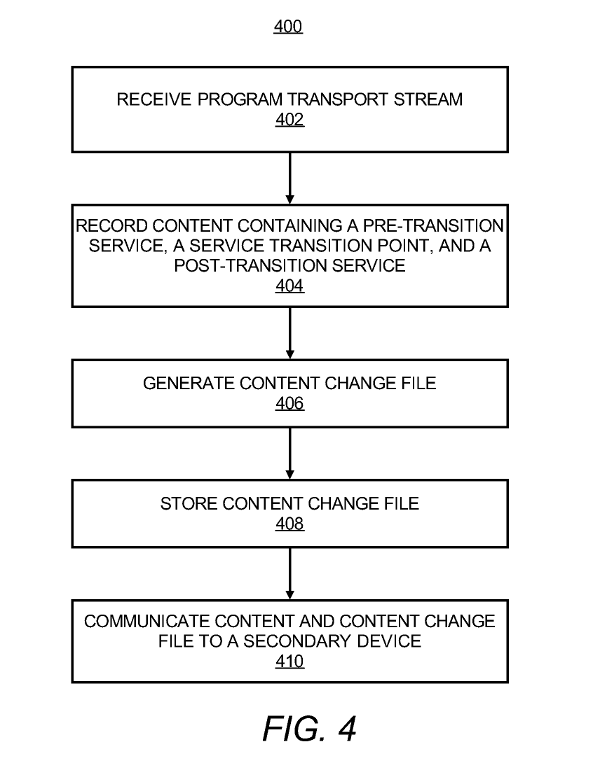

Various manners in which the modules 112-118 may be implemented are described in greater detail with respect to FIG. 4, which depicts a flow diagram of a method 400 for facilitating playback of recorded content containing a service transition point, according to an embodiment. It should be apparent to those of ordinary skill in the art that the method 400 represents a generalized illustration and that other steps may be added or existing steps may be removed, modified or rearranged without departing from a scope of the method 400.

The description of the method 400 is made with particular reference to the DVR 104 depicted in FIGS. 1 and 3 and thus makes particular reference to the elements contained in the DVR 104. It should however, be understood that the method 400 may be implemented in an apparatus that differs from the DVR 104 depicted in FIGS. 1 and 3 without departing from a scope of the method 400.

As shown therein, at step 402, a program transport stream containing content is received by the DVR 104, for instance, through the input module 112. The program transport stream 132 contains a pre-transition service 150 and a post-transition service 152, in which, the pre-transition service 150 service has a first set of PIDs and the post-transition service 152 has a second set of PIDs. In addition, at least a portion of the program transport stream 132 may be stored in the hard drive 120 as the program transport stream 132 is received through the input module 112. As discussed above, the pre-transition service 150 may be received from a first source and the post-transition service 152 may be received from a second source, which is different from the first source. As also discussed above, the pre-transition service 150 may include programming content and the post-transition service 152 may include a targeted advertisement or a switched digital video (SDV) service acquisition transition.

At step 404, the content containing the pre-transition service 150, the post-transition service 152, and the service transition point 154 is recorded, for instance, by the recording module 114. Thus, for instance, the content, which may comprise programming content, is stored along with additional content, which may comprise a targeted advertisement or another portion of the programming content received from a different source.

At step 406, a content change file is generated, for instance, by the content change file generating module 116. The content change file includes a plurality of content change records associated with the pre-transition service 150, the service transition point 154, and the post-transition service 152. In addition, a first content change record associated with a start of the pre-transition service 150 and a second content change record associated with a start of the post-transition service 152 at the service transition point 154 may be generated at step 406. Further, additional content change records associated with further post-transition services may also be generated at step 406.

The content change file generating module 116 may be configured to generate the content change file by processing the program transport stream 132 to identify when the content begins as well as the location of the service transition point 154 in the program transport stream 132. The location of the service transition point 154 may comprise a time and/or a distance metric. Thus, for instance, the location may comprise an amount of time from an initial time at which the service transition point 154 is located. In another example, the location may comprise an amount of data from an initial data value at which the service transition point 154 is located. More particularly, the content change file generating module 116 may identify the location of the service transition point 154 based upon at least one of a record file offset, a presentation timestamp, and a program timestamp of the service transition point from the initial value, etc.

The presentation timestamp (PTS) is a media time reference associated with the record session and is a linear count in time that is referenced from the beginning of the recording. The file offset is a number that indicates the position in the file during recording, for instance, in bytes, of when a service transition point 154 occurs. By way of example, the playback device 106 may use to PTS and/or the file offset to determine when its video decoder should render the video packet after being decoded.

Alternately, the content change file generating module 116 may receive an indication of the location of a service transition point 154 from a device external to the digital video recorder 104. For instance, in a switched digital video network (not shown), the external device may comprise, for instance, a groom and splice component (not shown) configured to identify and indicate the presence of the service transition point(s) 154 to the content change file generating module 116.

In any regard, the content change file generating module 116 is also configured to identify the PIDs as well as the program number of the pre-transition service 150 and the post-transition service 152. The content change file generating module 116 may identify this information from the content itself or may receive this information from another source.

According to an embodiment, at step 406, a first content change record associated with a start of the pre-transition service 150 is generated. The first content change record may include, for instance, information pertaining to the PID values of the pre-transition service 150, the service number of the pre-transition service 150, etc. The first content change record may also include information pertaining an initial time and data value of when the pre-transition service 150 is initiated. Thus, for instance, the first content change record may identify at least one of a presentation time stamp and a file offset of the pre-transition service 150 to an initial value, such as, a zero value.

In addition, at step 406, a second content change record associated with a start of the post-transition service 152 at the service transition point is generated. The second content change record may include, for instance, information pertaining to the PID values of the post-transition service 152, the service number of the post-transition service 152, etc. The second content change record may also include information pertaining one or more of an offset time from the initial time and a transition file offset from the initial data value contained in the first content change record. In addition, or alternatively, the second content change record may include a presentation time stamp, which indicates a time at which the service transition point 154 occurs.

Additional content change records may also be generated at step 406 for additional transitions in the program transport stream 132. The additional content change records may include information similar to the information discussed above with respect to the second content change record.

At step 408, the content change file generated at step 406 is stored in the hard drive 120, for instance, through the recording module 114. By way of example, the content change records including a video packet identifier (PID), an audio PID, a program clock reference (PCR) PID, and an Entitlement Control Message (ECM) PID of the pre-transition service 150 as well as the post-transition service 152 may be stored in the hard drive 120.

At step 410, the recorded content and the content change file stored at step 408 are communicated to the playback device 106, for instance, through the communication module 118. The playback device 106 is configured to utilize the information in the content change file to produce a relatively seamless transition from the pre-transition service 150 to the post-transition service 152 during playback of the recorded content. More particularly, for instance, through use of the information contained in the content change file, the playback device 106 may set its hardware decoders to play the correct PIDs at the correct time or location during playback, which may include fast-forwarding and rewinding, of the content at the service transition points 154. Thus, the playback device 106 may play the recorded content without substantial interruptions during the playback of the content during transitions between pre-transition services 150 and post-transition services 152. Although particular reference has been made to the playback device 106 utilizing the information contained in the content change file, the DVR 102 may also utilize the information contained in the content change file during playback of the recorded content to thus enable the DVR 102 to play the recorded content without substantial interruptions during the playback of the content during transitions between pre-transition services 150 and post-transition services 152.

Some or all of the operations set forth in the figures may be contained as a utility, program, or subprogram, in any desired computer readable storage medium. In addition, the operations may be embodied by computer programs, which can exist in a variety of forms both active and inactive. For example, they may exist as software program(s) comprised of program instructions in source code, object code, executable code or other formats. Any of the above may be embodied on a computer readable storage medium, which include storage devices, programmable hardware devices, such as, field-programmable gate arrays, etc.

Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

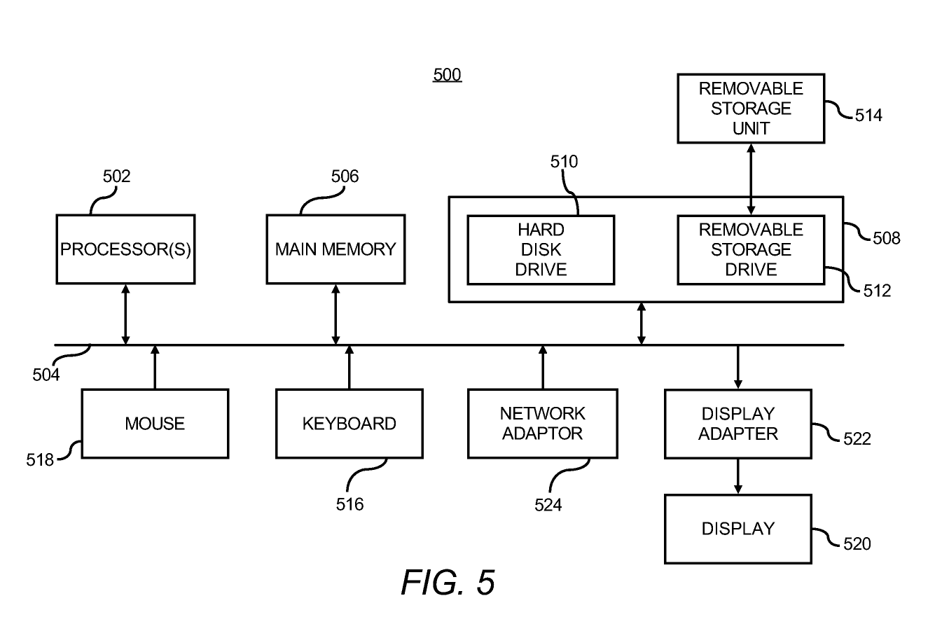

FIG. 5 illustrates a block diagram of a computing apparatus 500 configured to implement or execute one or more of the processes depicted in FIG. 4, according to an embodiment. It should be understood that the illustration of the computing apparatus 500 is a generalized illustration and that the computing apparatus 500 may include additional components and that some of the components described may be removed and/or modified without departing from a scope of the computing apparatus 500.

The computing apparatus 500 includes a processor 502 that may implement or execute some or all of the steps described in one or more of the processes depicted in FIG. 4. Commands and data from the processor 502 are communicated over a communication bus 504. The computing apparatus 500 also includes a main memory 506, such as a random access memory (RAM), where the program code for the processor 502, may be executed during runtime, and a secondary memory 508. The secondary memory 508 includes, for example, one or more hard disk drives 510 and/or a removable storage drive 512, representing a floppy diskette drive, a magnetic tape drive, a compact disk drive, etc., where a copy of the program code for one or more of the processes depicted in FIG. 4 may be stored.

The removable storage drive 510 reads from and/or writes to a removable storage unit 514 in a well-known manner. User input and output devices may include a keyboard 516, a mouse 518, and a display 520. A display adaptor 522 may interface with the communication bus 504 and the display 520 and may receive display data from the processor 502 and convert the display data into display commands for the display 520. In addition, the processor(s) 502 may communicate over a network, for instance, the Internet, LAN, etc., through a network adaptor 524.

Through implementation of the method and DVR disclosed herein, a playback device may receive the recorded content and content change file from the DVR and may use the content change file to facilitate seamless playback of the recorded content. More particularly, the playback device may seamlessly play the transitions between pre-transition services and post-transition services having different sets of PIDs through implementation of the method and digital video recorder disclosed herein.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are mean in their broadest reasonable sense unless otherwise indicated.

What is claimed is:

1. A method for facilitating playback of recorded content containing a service transition point, said method comprising:
recording content containing a pre-transition service and a post-transition service, wherein the pre-transition service occurs prior to the service transition point and the post-transition service occurs after the service transition point;
generating a content change file containing a plurality of content change records associated with the pre-transition service, the service transition point, and the post-transition service; and
communicating the content and the content change file to a playback device configured to play the recorded content.

2. The method according to claim 1, wherein generating the content change file further comprises:
generating a first content change record associated with a start of the pre-transition service; and
generating a second content change record associated with a start of the post-transition service at the service transition point.

3. The method according to claim 2, wherein generating the first content change record further comprises storing at least one of a presentation time stamp and a file offset of the pre-transition service with an initial value.

4. The method according to claim 2, wherein generating the first content change record further comprises storing at least one of a video packet identifier (PID), an audio PID, a program clock reference (PCR) PID, and an Entitlement Control Message (ECM) PID of the pre-transition service.

5. The method according to claim 3, wherein generating the second content change record further comprises:
identifying an occurrence of the service transition point;
identifying at least one of a record file offset, a presentation timestamp, and a program timestamp of the service transition point from the initial value; and
storing the identified at least one of the record file offset, the presentation timestamp, and the program timestamp of the service transition point.

6. The method according to claim 5, wherein generating the second content change record further comprises storing at least one of a video packet identifier (PID), an audio PID, a program clock reference (PCR) PID, and an Entitlement Control Message (ECM) PID of the post-transition service.

7. The method according to claim 2, wherein generating the content change file further comprises:
generating a third content change record associated with another post-transition service, wherein the another post-transition service occurs after the post-transition service.

8. The method according to claim 1, further comprising:
in the playback device, playing the recorded content using information contained in the content change file to produce a relatively seamless transition from the pre-transition service to the post-transition service during playback of the recorded content.

9. The method according to claim 1, wherein the pre-transition service is received from a first source and wherein the post-transition service is received from a second source, and wherein the first source differs from the second source.

10. The method according to claim 1, wherein the pre-transition service comprises programming content and wherein the post-transition service comprises at least one of a targeted advertisement and a switched digital video service acquisition transition.

11. A digital video recorder comprising:
a recording module configured to record content containing a pre-transition service, a service transition point, and a post-transition service, wherein the pre-transition service occurs prior to the service transition point and the post-transition service occurs after the service transition point;
a content change file generating module configured to generate a content change file containing a plurality of content change records associated with the pre-transition service, the service transition point, and the post-transition service; and
a communication module configured to communicate the content and the content change file to a playback device configured to play the recorded content.

12. The digital video recorder according to claim 11, wherein the content change file generating module is further configured to generate a first content change record associated with a start of the pre-transition service and to generate a second content change record associated with a start of the post-transition service at the service transition point.

13. The digital video recorder according to claim 12, wherein the recording module is further configured to store at least one of a presentation time stamp and a file offset of the pre-transition service with an initial value.

14. The digital video recorder according to claim 12, wherein the recording module is further configured to store at least one of a video packet identifier (PID), an audio PID, a program clock reference (PCR) PID, and an Entitlement Control Message (ECM) PID of the pre-transition service.

15. The digital video recorder according to claim 13, wherein the content change file generating module is further configured to identify an occurrence of the service transition point, to identify at least one of a record file offset, a presentation timestamp, and a program timestamp of the service transition point from the initial value, and to store the identified at least one of the record file offset, the presentation timestamp, and the program timestamp of the service transition point.

16. The digital video recorder according to claim 15, wherein the recording module is further configured to store at least one of a video packet identifier (PID), an audio PID, a program clock reference (PCR) PID, and an Entitlement Control Message (ECM) PID of the post-transition service.

17. The digital video recorder according to claim 11, wherein the pre-transition service is received from a first source and wherein the post-transition service is received from a second source, and wherein the first source differs from the second source.

18. The digital video recorder according to claim 11, wherein the pre-transition service comprises programming content and wherein the post-transition service comprises at least one of a targeted advertisement and a switched digital video service acquisition transition.

19. A computer readable storage medium on which is embedded one or more computer programs, said one or more computer programs implementing a method of facilitating playback of recorded content containing a service transition point, said one or more computer programs comprising a set of instructions for:
recording content containing a pre-transition service and a post-transition service, wherein the pre-transition service occurs prior to the service transition point and the post-transition service occurs after the service transition point;
generating a content change file containing a plurality of content change records associated with the pre-transition service, the service transition point, and the post-transition service; and
communicating the content and the content change file to a playback device configured to play the recorded content.

20. The computer readable storage medium according to claim 19, wherein the set of instructions for generating the content change file further comprises a set of instructions for:
generating a first content change record associated with a start of the pre-transition service; and
generating a second content change record associated with a start of the post-transition service at the service transition point,
wherein the first content change record includes information pertaining to packet identifier values and a reference location value of the pre-transition service; and
wherein the second content change record includes information pertaining to packet identifier values and a location value of the post-transition service.
